(19) United States
(12) Patent Application Publication
(10) Pub. No.: US 2013/0265234 A1
(43) Pub. Date: Oct. 10, 2013

(54) CONTROL CIRCUIT FOR DISPLAY DEVICE AND COMPUTER ASSEMBLY USING SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: GUI-FU XIAO, Shenzhen (CN); JIAN LI, Shenzhen (CN)

(73) Assignees: HON HAI PRECISION INDUSTRY CO., LTD., New Taipei (TW); HONG FU JIN PRECISION INDUSTRY (ShenZhen) Co. Ltd., Shenzhen (CN)

(21) Appl. No.: 13/726,008

(22) Filed: Dec. 22, 2012

(30) Foreign Application Priority Data
Apr. 9, 2012 (CN) 201210100792.0

(51) Int. Cl. G06F 3/02

(52) U.S. Cl. CPC G06F 3/0227
USPC 345/168

(57) ABSTRACT

A control circuit for a display device includes a group of keys, a video graphics array (VGA), and a control unit. The VGA port is electronically connected to the display device via a VGA bus. The control unit is electronically connected to the group of keys, and is electronically connected to the VGA port via an inter-integrated circuit (I2C) bus. The control unit outputs control signals when at least one key is actuated, and then the control signals is transmitted to the display device via the VGA port.

### BACKGROUND

1. Technical field

The disclosure generally relates to control circuits, and particularly to a control circuit for a display device and a computer assembly using the control circuit.

2. Description of the Related Art

Buttons placed on an exterior surface of a display device can be used to control the display device. For example, when an operator actuates the button, the display device can be turned on/off, or display color and brightness of the display device can be adjusted. However, when the display device is far away from the operator, the operator cannot conveniently manually control the display device by actuating the buttons.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a circuit view of a control circuit for display devices, according to an exemplary embodiment.

FIG. 2 is a schematic view of a keyboard of a computer assembly, according to an exemplary embodiment.

FIG. 3 is a schematic view of a host computer of the computer assembly, according to an exemplary embodiment.

### DETAILED DESCRIPTION

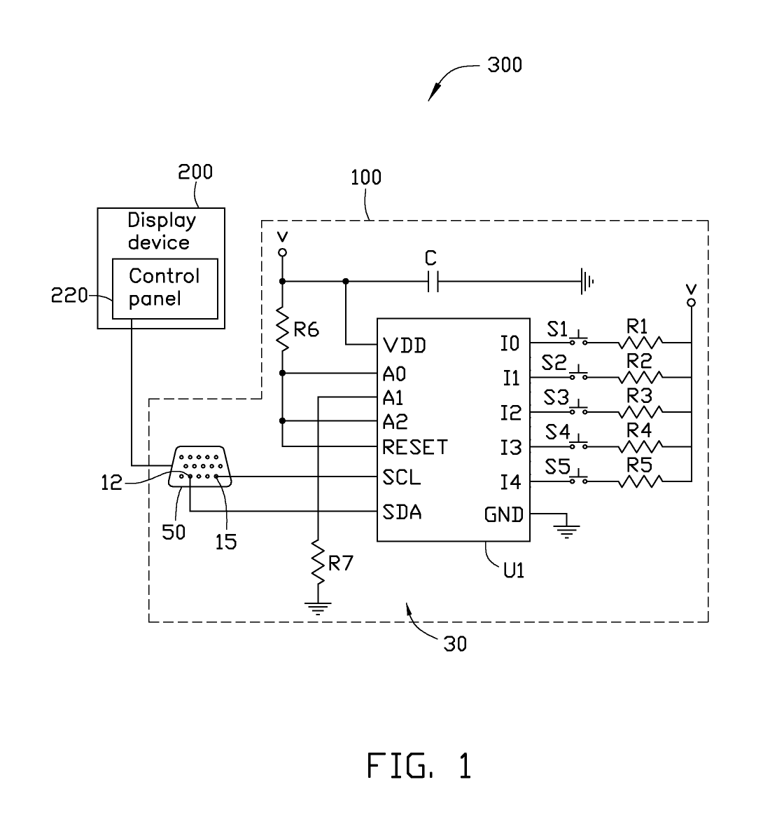

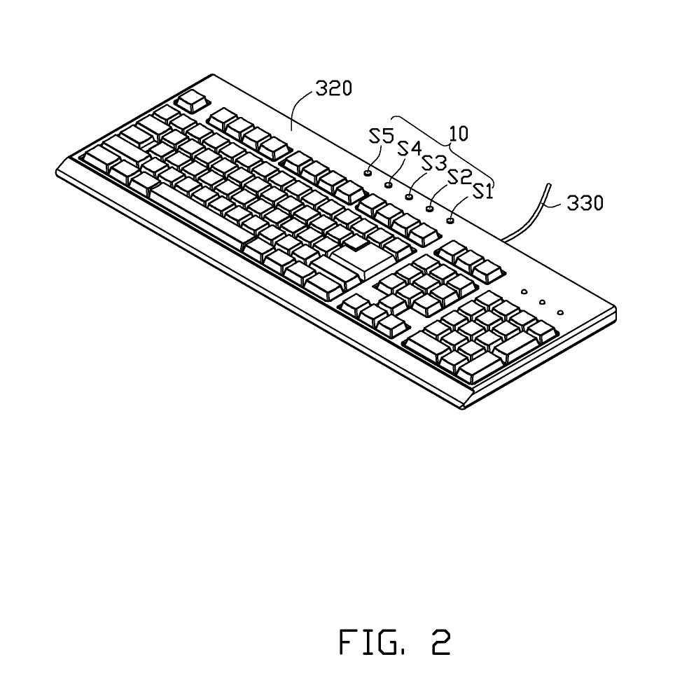

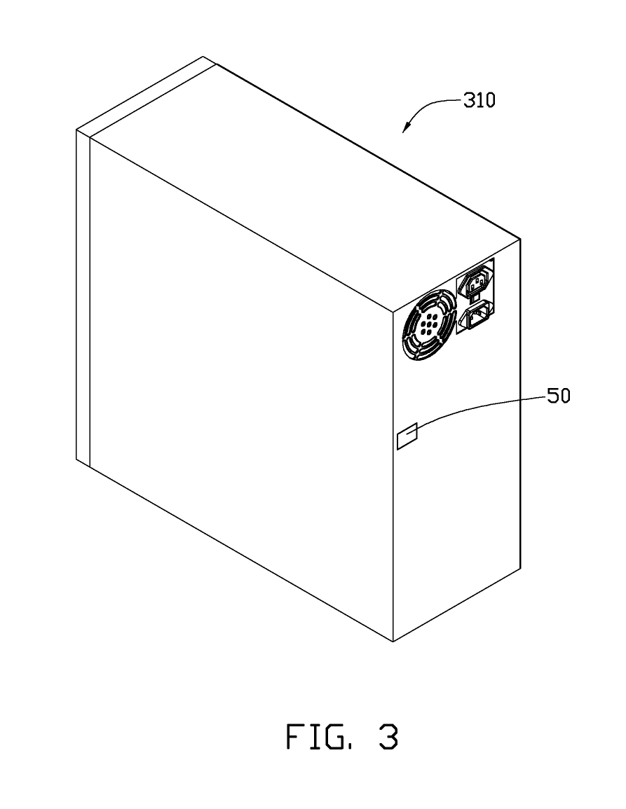

FIG. 1 shows a control circuit 100, according to an exemplary embodiment. The control circuit 100 can be integrated on a computer assembly 300, for controlling a display device 200 in electronic communication with the computer assembly 300. FIGS. 2-3 shows that in one exemplary embodiment, the computer assembly 300 further includes a host computer 310 and other computer peripheral equipment, such as a keyboard 320, for example.

The control circuit 100 includes a group of keys 10, a control unit 30, and a video graphics array (VGA) port 50. In one exemplary embodiment, the group of keys 10 and the control unit 30 can be integrated on the keyboard 320, and the VGA port 50 can be integrated with the host computer 310.

In one exemplary embodiment, the group of keys 10 includes five keys, and are respectively labeled as S1, S2, S3, S4, and S5. Functions of the keys S1-S5 are same as functions of common buttons on the display device 200, and can respectively represent functions of a power switch button, a menu selection button, a right shift button, a left shift button, and an automatic regulation button.

The control unit 30 is electronically connected to the group of keys 10, and is directed by the group of keys 10 to output control signals. The control unit 30 includes a controller U1, a capacitor C, and resistors R1, R2, R3, R4, R5, R6, and R7. The controller U1 includes a power pin VDD, five input pins I0, I1, I2, I3, and I4, three address pins A0, A1, and A2, a clock pin SCL, a data pin SDA, a reset pin RESET, and a grounding pin GND. The power pin VDD is electronically connected to a power supply V, and is connected to ground via the capacitor C. The address pins A0, A1, and A2 is configured to preset hardware addresses of the display device 200, to allow the controller U1 to access to the display device 200. The address pins A0 and A2 are electronically connected to the power supply V via the resistor R6, and the address pin Al is connected to ground via the resistor R7. The reset pin RESET is electronically connected to the power supply V via the resistor R6.

The five input pins I0, I1, I2, I3, and I4 are respectively and electronically connected to the keys S1-S5, and the keys S1-S5 are electronically connected to the power supply V respectively via the resistors R1-R5. When the keys S1-S5 are actuated, voltages of the input pins 10-14 are pulled up (e.g., logic 1), and then the control unit 30 outputs the control signals according to the voltages of the input pins 10-14. The clock pin SCL and the data pin SDA are electronically connected to the VGA port 50 via a keyboard cable 330 of the keyboard 320 and an inter-integrated circuit (I2C) bus of the host computer 310. The clock pin SCL outputs a clock signal to the VGA port 50, and the data pin SDA outputs the control signal to the VGA port 50. For example, if the key 51 is actuated, the voltage of the input pin I0 is pulled up, and then the data pin SDA outputs a control signal, such as “001”. If the key S3 is actuated, the voltage of the input pin 12 is pulled up, and then the data pin SDA outputs a control signal, such as “011”.

The VGA port 50 can be a common port of the host computer 310, and includes fifteen pins, a twelfth pin 12 and a fifteenth pin 15 are respectively and electronically connected to the data pin SDA and the clock pin SCL to receive the control signal and the clock signal. The VGA port 50 is further electronically connected to the display device 200 via a VGA bus, to transmit the control signal and the clock signal to a control panel 220 of the display device 200, for allowing the control panel 220 to control the display device 200.

When the display device 200 is positioned far away from an operator, the display device 200 can be controlled by manipulating the group of keys 10 integrated on the keyboard 320. For example, if a brightness of the display device 200 is needed to increase, the key S2 is actuated, and the voltage of the input pin I1 is pulled up. Thus, the data pin SDA outputs a control signal (e.g., 010) to the control panel 220 via the keyboard cable 330, the I2C bus of the host computer 310, the VGA port 50, and the VGA bus. The control panel 220 controls the display device 200 to display a selection menu including a brightness menu according to the control signal. Then, the key S2 is actuated again, and the brightness menu is selected. At last, the key S3 is actuated, and the data pin SDA outputs another control signal (e.g., 011) to the control panel 220 to increase the brightness of the display device 200.

In other exemplary embodiments, the group of keys 10, the control unit 30 and the VGA port 50 are all integrated on the host computer 310. The data pin SDA outputs the control signal to the VGA port 50 via the I2C bus. Thus, the keyboard 320 and the keyboard cable 330 can be omitted.

In summary, the group of keys 10 and the control unit 30 can be integrated on the computer assembly 300 which can be reached by the operator. Thus, when the keys 10 are actuated, the control unit 30 outputs the control signal to the display device 200 to control the display device 200. Therefore, the control circuit 100 can control the display device 200 at a relative distant position, and is both convenient and efficient.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A control circuit for a display device, the control circuit comprising:
a group of keys;
a video graphics array (VGA) port electronically connected to the display device via a VGA bus; and
a control unit electronically connected to the group of keys, and electronically connected to the VGA port;
wherein the control unit outputs control signals when at least one key is actuated, and the control signals is transmitted to the display device via the VGA port to turn on/off or to adjust the display device.

2. The delay circuit as claimed in claim 1, wherein the control unit includes a controller comprising a plurality of input pins, each input pin is electronically connected to one of the group of keys, and each key is electronically connected to a power supply via a resistor.

3. The delay circuit as claimed in claim 2, wherein the controller further includes a data pin electronically connected to the VGA port to transmit the control signals.

4. The delay circuit as claimed in claim 2, wherein the controller further includes a clock pin electronically connected to the VGA port to transmit a clock signal.

5. The delay circuit as claimed in claim 2, wherein the control further includes three address pins to preset hardware addresses of the display device, and the controller accesses to the display device according to the hardware addresses of the display device.

6. The delay circuit as claimed in claim 1, wherein the group of keys and the control unit are integrated on a keyboard, and the VGA port is integrated on a host computer.

7. The delay circuit as claimed in claim 1, wherein the group of keys, the control unit, and the VGA port are all integrated on a host computer.

8. A computer assembly, comprising;
a host computer; and
a control circuit, the control circuit comprising a group of keys, a control unit, and a video graphics array (VGA), the VGA port integrated with the host computer, and configured to be electronically connected to a display device via a VGA bus, the control unit electronically connected to the group of keys, and electronically connected to the VGA port via an inter-integrated circuit (I2C) bus;
wherein in response to actuation of the keys, the control unit outputs control signals to the display device via the VGA port to control the display device.

9. The computer assembly as claimed in claim 8, further comprising a keyboard, wherein the group of keys and the control unit are integrated on the keyboard.

10. The computer assembly as claimed in claim 9, wherein the keyboard includes a keyboard cable, and the control unit outputs the control signal via the keyboard cable.

11. The computer assembly as claimed in claim 8, wherein the control unit includes a controller comprising a plurality of input pins, each input pin is electronically connected to one of the group of keys, and each key is electronically connected to a power supply via a resistor.

12. The computer assembly as claimed in claim 11, wherein the controller further includes a data pin electronically connected to the VGA port to transmit the control signals.

13. The computer assembly as claimed in claim 8, wherein the group of keys and the control unit are integrated on the host computer.
